(19) United States
(12) Patent Application Publication
(10) Pub. No.: US 2019/0287005 A1
(43) Pub. Date: Sep. 19, 2019

(54) DIAGNOSING AND PREDICTING ELECTRICAL PUMP OPERATION

(71) Applicant: GE Inspection Technologies, LP, Lewistown, PA (US)

(72) Inventors: Arun Karthi Subramaniyan, Lewistown, PA (US); Fabio Nonato de Paula, Lewistown, PA (US); Michael Kennedy, Lewistown, PA (US); Mahadevan Balasubramaniam, Lewistown, PA (US); Shyam Sivaramakrishnan, Lewistown, PA (US); Andrea Panizza, Lewistown, PA (US)

(21) Appl. No.: 16/354,827

(22) Filed: Mar. 15, 2019

Related U.S. Application Data
(60) Provisional application No. 62/645,126, filed on Mar. 19, 2018.

(51) Int. Cl. G06N 5/04; G06F 17/50; G06N 20/00; F04B 51/00

(52) U.S. Cl. CPC G06N 5/04; G06F 17/5009; E21B 43/128; F04B 51/00; G06N 20/00

(57) ABSTRACT

Systems, methods, and a computer readable medium are provided for generating natural language recommendations based on an industrial language model. Operational data associated with an operating condition of a pump is received and provided as inputs to a predictive model used to determine diagnostic and prognostic data associated with the pump. The diagnostic and prognostic data can include a plurality of metrics associated with the pump that are predicted in relation to the operational data. The predicted diagnostic and prognostic data can be transmitted by and/or to one or more computing systems.

### CROSS-REFERENCE TO RELATED APPLICATIONS

The present application claims priority under 35 U.S.C. § 119 to U.S. Provisional Application No. 62/645,126 entitled “ESP Diagnostics and Prognostics” filed on Mar. 19, 2018, which is hereby expressly incorporated by reference in its entirety.

### BACKGROUND

An oil and gas production environment can include multiple well sites, each configured with one or more electrical pumping systems that are used to collect oil for further processing and distribution. The pumping systems can include a variety of machinery used in the production process, such as electrical submersible pumps (ESPs). The ESPs can be configured to include sensors capable of transmitting sensor data that can be used to monitor operating conditions of the pump. The operating conditions can indicate the current performance or operational state of the ESP at a specific and immediate moment in time.

An ESP can experience a wide variety of operating conditions over its operational lifetime that are associated with the mechanical, electrical and fluidic operation of the ESP. Monitoring ESP operational data can be a valuable practice to ensure ESPs are performing as specified within stable operating conditions. Unstable or undesirable operating conditions can reduce the performance of the ESP and thereby reduce an amount of remaining useful life for the ESP to remain in operation. Anomalous operating conditions can cause ESP shutdowns when operating conditions are determined to be outside of safe or expected operating condition ranges. ESP shutdowns can reduce the oil or gas production for a particular well site which can increase maintenance and production costs and strain already reduced workforces.

Machine learning is an application of artificial intelligence that automates the development of an analytical model by using algorithms that iteratively learn patterns from data without explicit indication of the data patterns. Machine learning is commonly used in pattern recognition, computer vision, language processing and optical character recognition and enables the construction of algorithms that can accurately learn from data to predict model outputs thereby making data-driven predictions or decisions. Machine learning can be utilized to develop a predictive model capable of determining and generating diagnostic and prognostic data for an electrical pump based on operational data of the pump.

### SUMMARY

In one aspect, methods for are provided. In one embodiment, the method can include receiving operational data associated with an operating condition of a pump. The method can also include determining prognostic data using the received operational data and a first predictive model trained to receive operational data and, in response to the receiving, generate prognostic data associated with the pump. The prognostic data including a plurality of metrics associated with the pump and predicted in relation to the operational data. The method can further include transmitting the prognostic data. The method can also include performing at least one of the receiving, the determining, and the transmitting by at least one data processor forming part of at least one computing system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### DESCRIPTION OF DRAWINGS

These and other features will be more readily understood from the following detailed description taken in conjunction with the accompanying drawings, in which:

FIG. 1 is a block diagram illustrating an example architecture for generating diagnostic and prognostic data for an electrical pump using operational data and a predictive model;

FIGS. 2A-2B illustrate example block diagrams of systems for generating diagnostic and prognostic data for an electrical pump using operational data and a predictive model;

FIG. 3 a is a block diagram illustrating one exemplary embodiment of an architecture for training a model to generate diagnostic and prognostic data for an electrical pump;

FIG. 4 is a flowchart illustrating one exemplary embodiment of a method for generating diagnostic and prognostic data for an electrical pump using operational data and a predictive model using the client/server architecture of FIG. 1; and

FIG. 5 is a diagram illustrating one exemplary embodiment of a graphical user interface for displaying diagnostic and prognostic data for an electrical pump; and

FIG. 6 is a diagram illustrating one exemplary embodiment of a graphical user interface for displaying diagnostic and prognostic data for multiple electrical pumps.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Electrical submersible pumps (ESPs) are an efficient and reliable artificial-lift device configured to bring moderate to high volumes of fluids to the surface from the wellbores in which they are submerged. ESPs are frequently interfaced to sensors that are configured to collect operational data pertaining to a particular operating condition or measurement variable associated with the ESP. Typically, such sensor data can provide operators with insight about the condition, production rate, and operational performance of the ESP itself as well as specific components of the ESP.

However, the ESP sensor data is limited to data that has been received in the past or in the present moment and thus is associated with the historical or recent operating conditions. In this way, the sensor data provides limited insight into the future operational performance or remaining operational lifespan of an ESP. Oil and gas production operators need systems and methods that can be configured to provide insight into future operating conditions such as the remaining operational lifespan, also known as a remaining useful life, of an ESP. Being able to determine future operating conditions of ESPs would allow operators to better mitigate and plan for ESP failures which can be expensive and require complex logistical efforts to source, install and configure of ESP replacements in order to restore a well site to full production capacity. Providing operators with future operating condition data allows the operators to source replacement ESPs or parts in advance, better manage ESP resources, and minimize ESP down-time.

While determining an amount of remaining useful life for an ESP may address longer term ESP operation, oil and gas production operators also require systems and methods to monitor and diagnose more immediate conditions of ESP operation. The received sensor data can include large amounts of operational data from many ESPs or ESP components that can be challenging to review and manage manually. While ESP diagnostic systems can be automated to reduce the manual burden of reviewing the large volume of sensor data, such systems can require extensive manual configuration to input operating condition thresholds used to evaluate the sensor data for anomalous operating conditions. One drawback to such systems is the need to define the anomalous operating conditions in advance and to tune the operating condition thresholds to adequately detect when an ESP is operating outside of its desired or specified operating conditions. For example, traditional ESP diagnostic systems may evaluate threshold violations for a single operating condition variable or multivariate behavior for groups of operating condition variables. This can increase the costs and complexity of the condition monitoring system itself and require a more technically skilled workforce to deploy and operate such systems. In addition, such systems can be limited to detect only previously known anomalies and can be unable to determine anomalous data because the system has not been configured with prior knowledge of the characteristics of an anomalous operating condition or a particular ESP or sensor which may be providing the anomalous data.

An improved ESP diagnostic and prognostic system can be configured to receive operational data from one or more ESPs and to automatically determine prognostic data associated with longer-term operating conditions, such as an amount of remaining useful life. The improved ESP diagnostic and prognostic system can also be configured to determine diagnostic data associated with more near-term operating conditions, such as one or more anomalies associated with sensor data that can be received from an ESP or a component of an ESP. Such an improved ESP diagnostic and prognostic system can provide oil and gas production operators with greater insight into the current operating conditions of ESPs deployed at a well site and can also aid forecasting future operational capacity based on the amount of useful life remaining in an ESP. The improved ESP diagnostic and prognostic system can generate data about current and future operating conditions to assist operators in planning inventories of replacement parts, determining schedules and logistics for replacing ESPs or the ESP components, while maintaining production of a well site at acceptable and profitable levels.

Thus, systems and methods to automatically determine and generate ESP diagnostic and prognostic data based on ESP operational data may significantly increase the operational performance and longevity of ESPs deployed at a well site. In addition, an improved ESP diagnostic and prognostic system can reduce the number of skilled resources required to detect and characterize sensor data in order to determine anomalous operating conditions. For example, operational data received from sensors coupled to an ESP or its components can be received and processed by the improved ESP diagnostic and prognostic system and the results can be provided in a graphical user interface (GUI) configured to display diagnostic data, such as anomalous sensor data, and/or prognostic data, such as metrics related to amounts of operational capacity remaining in the ESP or its components. Without an improved system as will be described further herein, substantial computing resources would be required to collect sensor data from each ESP and/or its components and to process the data to determine diagnostic and prognostic data and to provide the data for display in a single, unified GUI allowing users to view and interact with the data.

An ESP diagnostic and prognostic system is provided herein including systems, methods, and computer-readable mediums for determining and generating diagnostic and prognostic data for an ESP based on operational data collected from sensors coupled to the ESP. The generated diagnostic and prognostic data are determined and generated by a predictive model that has been trained in a machine learning process to receive operational data associated with an ESP or its components and to generate diagnostic data, including anomalous operating conditions related to an ESP or its components, and prognostic data, including measurements of remaining useful life of the ESP or its components. The ESP diagnostic and prognostic system can also include a GUI to present the diagnostic and prognostic data for one ESP or a fleet of multiple ESPs in a dashboard-like display that can be configured based on user preferences. The GUI can be configured to allow users to interact with the data, for example by filtering or sorting the data. The GUI can also be configured to execute functionality related to one ESP or multiple ESPs based on the users' interaction with the GUI.

Embodiments of systems and corresponding methods for generating diagnostic and prognostic data based on operational data associated with an ESP are discussed herein. However, embodiments of the disclosure can be employed for generating diagnostic and prognostic data based on operational data associated with other types of machinery without limit.

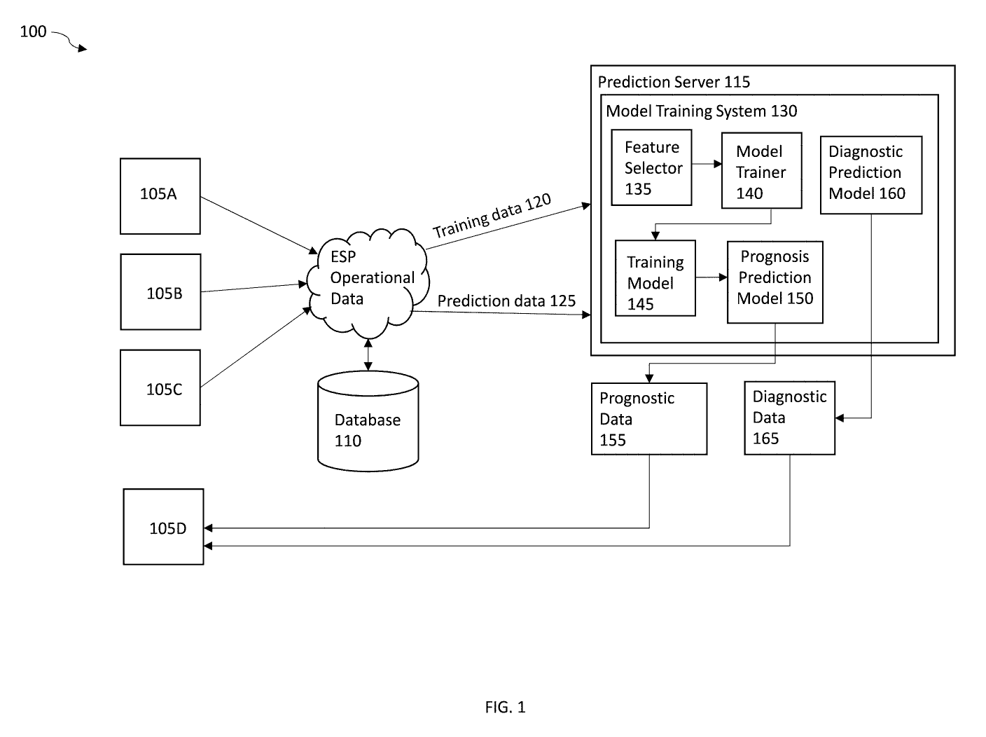

FIG. 1 is a block diagram illustrating an example architecture 100 for generating diagnostic and prognostic data for an electrical pump using operational data and a predictive model. The architecture 100 includes clients 105, database 110, and prediction server 115, which can be communicatively coupled over a network.

As shown in FIG. 1, the architecture 100 includes clients 105, e.g., clients 105A-105D. The clients 105 can be configured with data sources storing ESP operational data, such as clients 105A-105C. For example, the ESP operational data can transmitted from one or more sensors that are configured on the ESP. In some embodiments, the clients 105 can include one or more computing devices configured in a supervisory control and data acquisition (SCADA) systems which can include a control system architecture using computers and networked data communications to monitor and control machinery or systems of machinery based on received sensor data. In some embodiments, the clients 105 can transmit the ESP operational data as streaming data that is collected and transmitted in real-time or near real-time.

The clients 105 can include a large-format computing devices or any other fully functional computing device, such as a desktop computers or laptop computers, can transmit ESP operational data to prediction server 115. Additionally, or alternatively, other computing devices, such as a small-format computing devices 105 can also transmit ESP operational data to the prediction server 115. Small-format computing devices 105 can include a tablet, smartphone, personal digital assistant (PDA), or any other computing device that can have more limited functionality compared to large-format computing devices. For example, client 105A can include a laptop configured with a web-browser to display a sensor management application configured with respect to a number sensors coupled to one or more ESPs located within one or more wells at an oil field. Client 105B can include a sensor coupled to the wellhead and configured to transmit wellhead pressure data as operational data. Client 105C can include an ESP controller configured to transmit ESP voltage data as operational data. Additionally, client 105D can include a computing device configured to display diagnostic and prognostic data associated with the ESP operational data received from clients 105A-105C.

The architecture 100 also includes a database 110 that can store ESP operational data received from the clients 105 or from other computing devices via a network. In some embodiments, the database 110 can store historical ESP operational data associated with past failures or undesirable operating conditions exhibited by one or more ESPs. The database 110 can also store ESP operational data that can be used as training data, such as training data 120, which can be used to train one or more predictive models. In some embodiments, the databased 110 can also store ESP operational data that can be used as prediction data, such as prediction data 125, which can be used by the prediction server 115 to determine and generate the predicted prognostic data 155 and the diagnostic data 165. The database 110 can further store the diagnostic and prognostic data generated by the prediction server 115.

As further shown in FIG. 1, ESP operational data ESP operational data can be transmitted from the clients 105 and/or from the database 110 to the prediction server 115. In some embodiments, the ESP operational data includes training data 120 that is transmitted to the prediction server 115 for use in a machine learning process. The training data 120 is used to train a machine learning algorithm in a machine learning process in order to generate a training model capable of predicting prognostic data 155 and diagnostic data 165 based on a wide variety of received ESP operational data. In some embodiments, the ESP operational data include prediction data 125 that is transmitted to a prediction server 115 as inputs to the generated model that was trained in the machine learning process using the training data 120. In some embodiments, the ESP operational data, provided as prediction data 125, can also be provided to the prediction server 115 as inputs to one or more predictive models developed using supervised and unsupervised machine learning methods. The ESP operational data can include data that may be received from a particular ESP, multiple ESPs, as well as one or more components of an ESP, such as a motor, an intake, a sensor, or the like. The ESP operational data may include voltage data, current data, frequency data, vibration data, load data, or the like associated with an operating condition of the ESP. For example, the operational data may be received by the client 105 in regard to a motor failure, a pump failure, a cable or motor lead extension failure, a seal failure, a shaft and/or coupling failure, or the like. For example, the ESP operational data can include vibration data collected at a lower (less-frequent) sampling rate from a sensor monitoring a spinning rotor shaft within the ESP. The improved ESP diagnostic and prognostic system 100 would be trained to identify this input as a transient vibrational anomaly in the operational data of the ESP occurring over longer periods of time. Thus the improved ESP diagnostic and prognostic system 100 may not be limited to the lower sampling rates associated with the ESP operational data. As a result, the improved ESP diagnostic and prognostic system 100 may determine that the ESP is operating as desired and that the transient vibration is associated with a foreign object that may be brushing against the rotor shaft of the ESP. Without the improved ESP diagnostic and prognostic system 100, the operational data, including the vibration anomaly associated with the foreign object, may cause the production operator to immediately cease ESP and well site operations to further diagnose the observed anomaly. Using the improved ESP diagnostic and prognostic system 100, a production operator can determine the transient vibration is an anomaly due to a foreign object and that the ESP is operating as intended. As a result, the operator may perform only a minor shutdown of the ESP to inspect and remove the foreign object instead of a complete shutdown of the ESP.

As shown in FIG. 1, the architecture 100 includes a prediction server 115 configured to receive the ESP operational data and generate prognostic data 155, such as remaining useful life data, and diagnostic data 165, such as anomaly data. The prediction server 115 includes a model training system 130 configured to train a predictive model in a supervised machine learning process for use in determining and generating prognostic data 155. The model training system 130 can also be configured to train a model in an unsupervised machine learning process for use in determining and generating diagnostic data 165. In broad overview, the prediction server 115 functions in the training aspect of a machine learning process to receive ESP operational data and/or operational data stored in databased 110 as training inputs and generates a training model for use in predicting prognostic data 155 including measurements of an amount of remaining useful life or operating capacity associated with a particular ESP or one or more components of the ESP. In some embodiments, the prediction server 115 functions in the training aspect of a machine learning process to receive ESP operational data as training inputs to an unsupervised machine learning process to train a predictive model, anomaly detector 160, to generate diagnostic data 165 including anomaly data associated with the ESP from which the operational data was collected.

The model training system 130 configured on the prediction server 115 includes a feature selector 135, which is used in the supervised training aspect of the machine learning process to select subsets of features in the ESP operational data. The model training system 130 also includes a model trainer 140 which uses a selected machine learning algorithm to process the selected subsets of features and generate a new training model 145. The new training model 140 can be subsequently used outside of the machine learning process as a prognosis prediction model 150 configured to predict prognostic data 155 based on the received the prediction data 125.

As shown in FIG. 1, the prediction server 115 includes a feature selector 135. During the training aspect of the supervised machine learning process, the feature selector 135 receives ESP operational data and selects subsets of features in the ESP operational data which are used as training input to train the selected machine learning algorithm. For each selected subset of features in the training input 120, the selected machine learning algorithm can be trained to predict prognostic data 155 that may be associated with the subset of features for which the selected machine learning algorithm was trained. The trained machine learning algorithm can then be output as a new trained prognosis prediction model (e.g., training model 150), which can then be subsequently applied to ESP operational data (e.g., prediction data 125) to determine prognostic data 155 including measurements associated with an amount of remaining useful life for an ESP or a component of the ESP.

The prediction server 115 also includes a model trainer 140. In some embodiments, the model trainer 140 can be included in the prediction server 115. In other embodiments, the model trainer 140 can be located remotely from the prediction server 115. During the training aspect of the supervised machine learning process, the model trainer 140 receives the training input including the selected subsets of features of the ESP operational data from the feature selector 135 and iteratively applies the subsets of features to the previously selected machine learning algorithm to assess the performance of the algorithm. As the supervised machine learning algorithm processes the training input, the model trainer 140 learns patterns in the training input that map the machine learning algorithm variables to the target output data (e.g., the predicted prognostic data 155) and generates a training model 145 that captures these relationships. For example, as shown in FIG. 1, the model trainer 140 outputs the training model 145. As further shown in FIG. 1, the training model 145 that is output can be subsequently deployed as a standalone trained prediction model, such as the trained prognosis prediction model 150.

As further shown in FIG. 1, the prediction server 115 includes a trained prognosis prediction model 150. The prognosis prediction model 150 is a model or algorithm that has been generated as a result of the model training performed during the training aspect of the supervised machine learning process. Once trained, the prognosis prediction model 150 can operate outside of a machine learning process to receive user data as prediction data 125 and generate prognostic data 155 for a given ESP or ESP component. For example, the prognosis prediction model 150 generates failure prediction measurements and data corresponding to an amount or remaining useful life based on the ESP operational data. The prognostic data 155 can include time-based survivability measurements, such as a thirty or 30-day survivability measurement. In some embodiments, the time-based survivability measurement can include 45-day, 60-day, and/or 90 day survivability estimate. The prognostic data 155 can also include a Weibull distribution indicating the probability of ESP failure as a function of time. The prognostic data 155 can also include confidence intervals or uncertainty bounds. In some embodiments, the prognosis prediction model 150 can be deployed on the prediction server 115 or can be deployed in a configuration that is remotely located from, yet communicatively coupled to, the prediction server 115.

As further shown in FIG. 1, the model training system 130 includes a diagnostic prediction model 160. The diagnostic prediction model 160 can include one or more predictive algorithms trained in an unsupervised machine learning process to receive ESP operational data as inputs, such as prediction data 125 inputs, and to determine and generate diagnostic data 165. For example, based on receiving streaming ESP operational data, the diagnostic prediction model 160 can learn the normal or expected operating conditions associated with the ESP. In this way, the diagnostic prediction model 160 can detect anomalous operational data without any prior knowledge about the types of sensors, the configuration of the ESP, and/or the characteristics of the ESP operational data. The diagnostic prediction model 160 provides the benefit of detecting failure modes and anomalous operating conditions without requiring explicit training as is required in a supervised machine learning process. The diagnostic prediction model 160 can be configured to generate diagnostic data 165 when it is not feasible or cost-effective to develop rules to determine known failure modes, for example, when new equipment has been deployed or when new failure modes are observed. The diagnostic data 165 can include detected anomalous operational data and also alerts or notifications that can be generated based on the diagnostic data 165.

In some embodiments, the diagnostic prediction model 160 can be configured within or separately from the model training system 130. In some embodiments, the diagnostic prediction model 160 can be configured within the prediction server 115. In some embodiments, the diagnostic prediction model 160 can be communicatively coupled to the prediction server 115 but located remotely from the prediction server 115. For example, the diagnostic prediction model 160 can be located in a remote, cloud computing environment that is coupled to the clients 105 via a network. In some embodiments, the diagnostic prediction model 160 can be located in proximity to the configuration of ESPs, also known as an “edge” configuration.

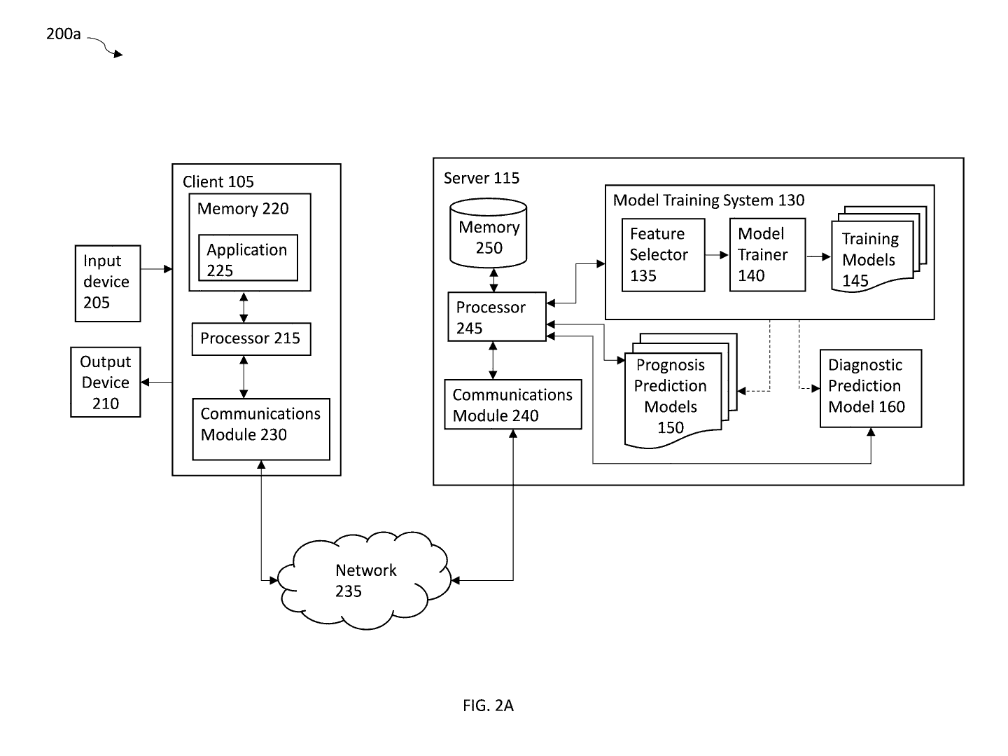

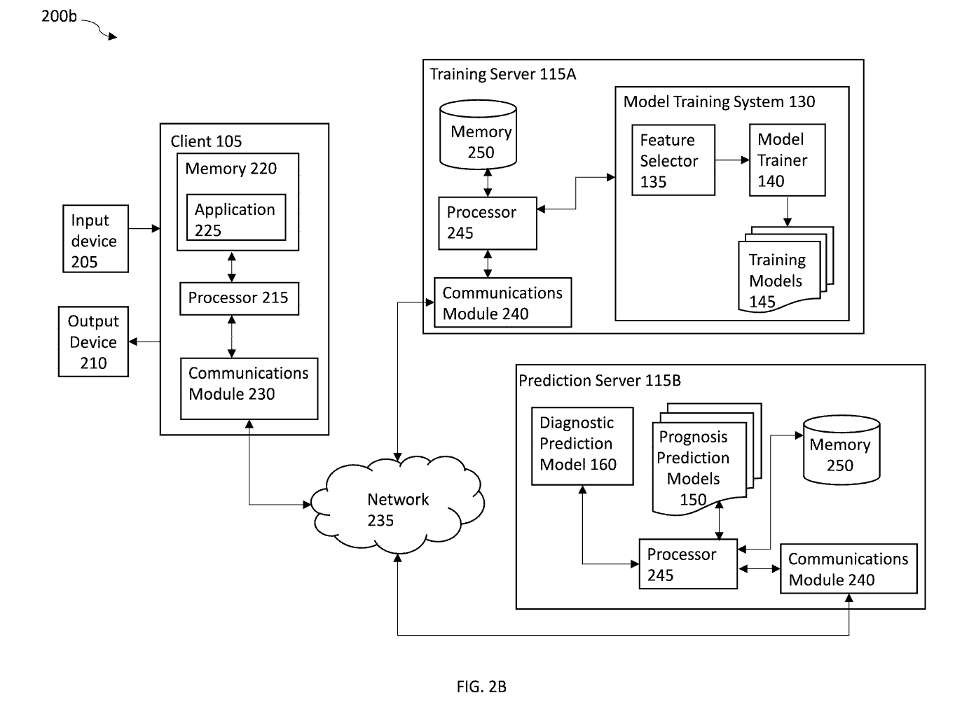

FIG. 2A is an example block diagram of a system 200a for predicting diagnostic and prognostic data based on ESP operational data using machine learning according to some embodiments. System 200a includes an input device 205 and an output device 210 coupled to a client 105, such as any of the clients 105 described in relation to FIG. 1.

As shown in FIG. 2A, the client 105 includes a processor 215 and a memory 220 storing an application 225. The client 105 also includes a communications module 230 connected to network 235. System 200a also includes a server 115, such as the prediction server 115 described in relation to FIG. 1. The server 115 includes a communications module 240, a processor 245 and a memory 250. The server 115 also includes a model training system 130. The model training system 130 includes a feature selector 135, a model trainer 140 and one or more training models 145. The model training system 130255 includes similar components and performs similar operations as the prediction server 115 shown in FIG. 1, except where indicated otherwise in the foregoing description. The server 115 also includes one or more trained prognosis prediction models 150 trained via a supervised machine learning process and a trained diagnostic prediction model 160 trained via an unsupervised machine learning process. The prognosis prediction models 150 and the diagnostic prediction model 160 are shown in dotted lines to indicate that the training models 145, which were output during the training performed in one of the machine learning processes can be one or more trained prediction models, such as the one or more prognosis prediction models 150 and the diagnostic prediction model 160.

As shown in FIG. 2A, the system 200a includes an input device 205. The input device 205 receives user input and provides the user input to client 105. The input device 205 can include a keyboard, mouse, microphone, stylus, game controller, joy stick, hand/or any other device or mechanism used to input ESP operational data to an application or user interface on a client, such as client 105. In some embodiments, the input device 205 can include haptic, tactile or voice recognition interfaces to receive the user input, such as on a small-format device. In some embodiments, the input device 205 can be an input device associated with a client 105 that is configured within a SCADA computing environment. The SCADA computing environment may include sensor monitoring applications that may be configured receive inputs, such as ESP operational data, and generate outputs, such as diagnostic and prognostic data.

The system 200a also includes a client 105. The client 105 communicates via the network 235 with the server 115. The client 105 receives input from the input device 205. The client 105 can be, for example, a large-format computing device, such as large-format computing device 105 as described in relation to FIG. 1, a small-format computing device (e.g., a smartphone or tablet), such as small-format computing device 105, or any other similar device having appropriate processor, memory, and communications capabilities to transmit ESP operational data. The client 105 can be configured to receive, transmit, and store ESP operational data associated with predicting diagnostic and prognostic data based on the ESP operational data received from client 105. The client 105 can be configured with one or more software applications. The software applications can include web-based applications as well as applications that can be directly hosted or configured on the client 105. For example, the software applications can include technical computing applications, modeling and simulation applications, sensor monitoring and configuration applications, ESP or asset management applications, ESP condition monitoring applications, as well as inventory management applications.

As further shown in FIG. 2A, the client 105 includes a processor 215 and a memory 220. The processor 215 operates to execute computer-readable instructions and/or data stored in memory 220 and transmit the computer-readable instructions and/or data via the communications module 230. The memory 220 can store computer-readable instructions and/or data associated with predicting diagnostic and prognostic data based on ESP operational data. For example, the memory 220 can include a database of ESP operational data received by the client 105, such as a database 110 as shown in FIG. 1. The memory 220 includes an application 225. The application 225 can be, for example, a sensor monitoring application configured to receive ESP operational data from one or more sensors coupled to an ESP and to the client 105 for use in assessing the operational performance of the ESP.

As shown in FIG. 2A, the client 105 includes a communications module 230. The communications module 230 transmits the computer-readable instructions and/or the ESP operational data stored on or received by the client 105 via network 235. The network 235 connects the client 105 to the server 115. The network 235 can include, for example, any one or more of a personal area network (PAN), a local area network (LAN), a campus area network (CAN), a metropolitan area network (MAN), a wide area network (WAN), a broadband network (BBN), the Internet, and the like. Further, the network 235 can include, but is not limited to, any one or more of the following network topologies, including a bus network, a star network, a ring network, a mesh network, a star-bus network, tree or hierarchical network, and the like.

As further shown in FIG. 2A, the server 115 operates to receive, store and process the computer-readable instructions and/or the ESP operational data generated and received by client 105. In some embodiments, the server 115 can receive ESP operational data directly from one or more clients 105. The server 115 can be any device having an appropriate processor, memory, and communications capability for hosting a machine learning process. In certain aspects, one or more of the servers 115 can be located on-premises with client 105, or the server 115 can be located remotely from client 105, for example in a cloud computing facility or remote data center. The server 115 includes a communications module 240 to receive the computer-readable instructions and/or the ESP operational data transmitted via network 235. The server 115 also includes one or more processors 245 configured to execute instructions that when executed cause the processors to train a predictive model during the training phase of a machine learning process and to determine predicted diagnostic and prognostic data based on the received ESP operational data during the prediction phase of a machine learning process. In some embodiments, the processor 245 can be a graphical processing unit (GPU). The improved ESP diagnostic and prognostic system described herein can leverage the processing power of GPUs to reduce model training time and increase prediction execution time.

The server 115 also includes a memory 250 configured to store the computer-readable instructions and/or ESP operational data associated with predicting diagnostic and prognostic data based on the received ESP operational data. In some embodiments, the memory 250 can store data which may be used in the training phase of the machine learning process. For example the memory 250 can store time-series datasets of ESP operational data, such as datasets associated with the operating conditions of a particular ESP over time. Additionally, or alternatively, the memory 250 can store streaming ESP operational data that has been received from customers in real-time or near real-time, as well as previously provided ESP operational data. In some embodiments, memory 250 can store one or more training models, such as the training models 145 used during the training of a machine learning process to generate a trained prediction models, such as the prognosis prediction model 150 and the diagnosis prediction model 160 configured to generate predicted prognostic and diagnostic data, respectively, that corresponds to the ESP operational data provided to application 225. In some embodiments, memory 250 can store one or more trained models, such as the prognosis prediction model 150 and the diagnosis prediction model 160 that were similarly generated during a machine learning process and were trained to generate predicted prognostic and diagnostic data for different types of ESPs, sensors, components of the ESP, or the like based on the ESP operational data provided to the applications by a user. In some embodiments, the memory 250 can store one or more machine learning algorithms that will be used to generate one or more training models 145. In some embodiments, the memory 250 can store ESP operational data that may be received from client 105 over a period of time and can be used as a training dataset in the machine learning process in order to train a prediction model. In some embodiments, the memory 250 can store one or more trained prediction models, such as variants of the prognosis prediction model 150 and/or the diagnosis prediction model 160 that may be used to predict prognostic and diagnostic data, respectively, based on ESP operational data.

As shown in FIG. 2A, the server 115 includes a model training system 130. The model training system 130 functions in a machine learning process to receive ESP operational data as training input and processes the inputs to train one or more training models. The model training system 130 includes a feature selector 135, a model trainer 140, and one or more training models 145. In some embodiments, the training models 145 that are generated and output as a result of the machine learning process are configured on server 115 as standalone components on server 115. For example, the trained prognosis prediction models 150 and the diagnostic prediction model 160 are configured on server 115 to process the ESP operational data and generate a prognostic and diagnostic data, respectively. In some embodiments, the trained prognosis prediction models 150 and the diagnostic prediction model 160 are stored in memory 250 on server 115.

The model training system 130 is configured to implement a supervised or unsupervised machine learning process that receives ESP operational data as training input and generates a training model that can be subsequently used to predict prognostic and diagnostic data based on ESP operational data that may be received by one or more clients 105. The components of the machine learning process operate to receive ESP operational data as training input, select unique subsets of features within the ESP operational data, use a machine learning algorithm to train a model based on the subset of features in the training input and generate a training model that can be output as a trained prediction model used for future predictions based on a variety of received ESP operational data.

As shown in FIG. 2A, the model training system 130 includes a feature selector 135. The feature selector 135 operates in the supervised machine learning process to receive the ESP operational data and select a subset of features from the inputs which will be provided as training inputs to a machine learning algorithm. In some embodiments, the feature selector 135 can select a subset of features corresponding to different categories of ESPs or sensors coupled to the ESPs that were used to generate and provide the ESP operational data such that the machine learning algorithm will be trained to predict prognostic data, such as measurements of an amount of remaining useful life for an ESP or ESP survivability based on the selected subset of features. In some embodiments, the feature selector 135 can select a subset of features corresponding to the type of ESP operational data provided as inputs to the clients 105, such as features that may be related to ESPs produced by different manufacturers, different sensor types, or different well site configurations where the ESPs are deployed. In some embodiments, the feature selector 135 can select a subset of features including direct variables representing sensor information. In some embodiments, the feature selector 135 can select a subset of features including derived information, such as non-dimensional parameters which may be associated with efficiency data corresponding to ESP mechanical or electrical power components.

During the supervised machine learning process, the feature selector 135 provides the selected subset of features to the model trainer 140 as inputs to a machine learning algorithm to generate one or more training models. A wide variety of machine learning algorithms can be selected for use including algorithms such as long short-term memory (LSTM), Recurrent Neural net architectures (RNN), Convolutional Auto Encoders, support vector regression, ordinary least squares regression (OLSR), linear regression, logistic regression, stepwise regression, multivariate adaptive regression splines (MARS), locally estimated scatterplot smoothing (LOESS), ordinal regression, Poisson regression, fast forest quantile regression, Bayesian linear regression, neural network regression, decision forest regression, boosted decision tree regression, artificial neural networks (ANN), Bayesian statistics, case-based reasoning, Gaussian process regression, inductive logic programming, learning automata, learning vector quantization, informal fuzzy networks, conditional random fields, genetic algorithms (GA), Information Theory, support vector machine (SVM), Averaged One-Dependence Estimators (AODE), Group method of data handling (GMDH), instance-based learning, lazy learning, and Maximum Information Spanning Trees (MIST).

The remaining useful life of a particular asset is dependent on how the asset arrived at this current state. Therefore, the history of operation of the asset has to be considered to make an accurate estimate of the life consumed in order to determine an amount of remaining available life. A conventional approach is to utilize stateful LSTM models and loop through every ESP during the training process to determine the weights. This approach, can result in lower training speeds because the batching of sequences during training cannot be leveraged. The training process can be accelerated by structuring the problem in a unique way such that the stateful information is converted into multiple sequences of stateless information. For example, a machine which has operated for 100 days can be solved in a linear unfolded manner (0, 1, 2, . . . , 100) or as stateless sequences as (0-10, 0-20, 0-30, 0-40, 0-50, . . . , 0-100) that can be matched with the observed remaining useful life. Performing this new training approach using enhanced processors, such as graphical programming units (GPUs), can mitigate the need for large, expensive computational resources and memory configurations. The stateless sequences can be shuffled and batched to gain speed in the training phase. With such an improved training approach, sequences which look backwards from failure (90-100, 80-100, 70-100 etc.) can also be leveraged to train the model. The model trainer 140 evaluates the machine learning algorithm's prediction performance based on patterns in the received subset of features processed as training inputs and generates one or more new training models 145. The training phase of the machine learning process can be configured to generate stateless sequences of ESP operational data. The model trainer 140 can then iteratively loop through the operational data from each ESP to create increasingly larger sequence lengths. The stateless sequences can then be shuffled and batched for processing, for example using a graphical processing unit (GPU) to achieve faster training execution time.

The generated training models, e.g., trained prognosis prediction models 150, are then capable of receiving ESP operational data from outside of the machine learning process in which they were trained and generated to output prognostic data as predicted measurements correlating to the future operational capacity or performance of an ESP.

As shown in FIG. 2A, the trained prognosis prediction models 150 that were generated as a result of performing the supervised machine learning process, can receive ESP operational data and process the inputs to output predicted prognostic data that can be optimized based on the ESP operational data and/or the clients 105 on which the ESP operational data were received or stored. For example, the trained prognosis prediction models 150, that were produced in the supervised machine learning process, can be subsequently be included in an artificial intelligence system or an application configured to receive ESP operational data as prediction inputs and process the data to output predicted measurements indicative of the prognosis or future operational state of an ESP. In some embodiments, the processor 245 can store the predicted prognosis data that were output from the trained prognosis prediction models 150 in memory 250. In other embodiments, the outputted prognosis data can be forwarded to communications module 240 for transmission to the client 105 via network 235. Once received by the client 105, the outputted prognosis data can be transmitted to output device 210, such as a monitor, printer, portable hard drive or other storage device.

As shown in FIG. 2A, the server 115 can also include a diagnostic prediction model 160. The diagnostic prediction model 160 can be trained in an unsupervised machine learning process configured on the server 115. During the unsupervised machine learning process, the diagnostic prediction model 160 can be trained to receive ESP operational data as inputs to a predictive model trained to generate diagnostic data including anomalous data signals which may be present within the received ESP operational data. The diagnostic prediction model 160 can learn to distinguish anomalous data within the ESP operational data over time without user input or explicit supervised training to map attributes of anomalous data to specific failure causes. In some embodiments, the diagnostic prediction model 160 can be trained using cluster analysis and/or convolutional neural networks. Clusters of ESP operational data, for example, ESP operational data associated with a cluster of similar type machines, are modeled using a measure of similarity which is defined upon metrics such as a Euclidian or probabilistic distance. Common clustering algorithms can include hierarchical clustering algorithms, k-means clustering algorithms, Gaussian mixture models, self-organizing maps including neural networks, and hidden markov models. In some embodiments, the clusters of ESP operational data can include ESP operational data associated multiple machines which may experience the same type of failure, such operational data from all machines experiencing ESP shaft failures or ESP pump failures.

FIG. 2B illustrates an example block diagram of a system 200b using a machine learning process configured on a model training server 115A. The individual components and functionality of each component shown and described in relation to model training server 115A in FIG. 2B are identical to the components and respective functionality shown and described in relation to server 115 of FIG. 2A with the exception that the model training server 115A shown in FIG. 2B does not include one or more trained prognosis prediction models 150 or a diagnostic prediction model 160 as shown in FIG. 2A.

Instead, as shown in FIG. 2B, the system 200b includes a training server 115A that is configured separately from the trained prediction models, e.g., the prognosis prediction models 150 and the diagnostic prediction model 160, that are now configured on the prediction server 115B. The prediction server 115B includes components and functionality similar to the server 115 shown in FIG. 2A with the exception that the prediction server 115B shown in FIG. 2B does not include a model training system, such as the model training system 130 shown in FIG. 2A. The prediction server 115B shown in FIG. 2B includes one or more trained prediction models. The trained prediction models configured on the prediction server 115B include the prognosis prediction models 150 and the diagnostic prediction model 160 or algorithms that were generated from a machine learning process, such as training models 145 and have been trained in the machine learning process to generate diagnostic and prognostic data based on ESP operational data provided to or stored on a client 105. For example, upon receiving ESP operational data from a client, for example client 105, the prognosis prediction models 150 can be employed to generate one or more predicted measurements of an amount of remaining useful life that are optimized based on the received ESP operational data. Similarly, the diagnostic prediction model 160 can be employed to generate diagnostic data including determinations of anomalous data associated with the received ESP operational data. In some embodiments, each of the prognosis prediction models 150 and the diagnostic prediction model 160 can generate outputs for a specific ESP, a fleet of multiple ESPs, a component of a specific ESP, a component common to multiple ESPs, a sensor, or the like. In some embodiments, each of the prognosis prediction models 150 and the diagnostic prediction model 160 can generate the respective prognosis data and the diagnostic data based on a specific input format of the ESP operational data such as time-based operational data associated with the operation of an ESP or a component of the ESP over a period of time including a minute, hour, 12-hours, a day, multiple days, a week, a month, or a year.

As shown in FIG. 2B, system 200b also includes a training server 115A. The training server 115A includes a model training system 130 which implements a supervised and/or unsupervised machine learning process and includes a feature selector 135, a model trainer 140, and one or more training models 145. In some embodiments, the training server 115A can be located in the same location as prediction server 115B. In other embodiments, the training server 115A can be located in a remote location, for example in a second data center that is separately located from the data center or client location where the prediction server 115B is located. In some embodiments, the training system 130, configured on the training server 115A, can be utilized to evaluate different machine learning algorithms and generate one or more alternate training models 145. For example, based on using different subsets of features in the received ESP operational data as the training inputs to a different machine learning algorithm and process, the model training system 130 can train and output a different training model 145 than the trained prognostic prediction models 150 and/or the trained diagnostic prediction model 160 configured on prediction server 115B which can have been trained using a separate machine learning algorithm and process.

The training system 130 can also be configured with a machine learning process to train and output one or more prognosis prediction models 150 and diagnostic prediction models 160 that are capable of generating prognostic and diagnostic data based on historical ESP operational data which may have been provide by a user in the past and can be stored in memory 220 or memory 250. In some embodiments, the training system 130 can generate a model, such as trained prognosis prediction models 150 and the diagnostic prediction model 160 which can be capable of generating prognostic and diagnostic data when one or more features of the ESP operational data which are traditionally used to determine a particular aspect of the prognostic and/or diagnostic data are not available. For example, the prognostic and diagnostic data predicted for a specific ESP can be optimized based on the ESP operational data which may only partially identify the specific ESP, for example by a portion of time-series data or a data set including only a subset of available sensor data corresponding to a particular ESP configuration as opposed to a more complete data set of ESP operational data received for a full reporting time period or a data set including all available sensor data.

The training system 130 can also be configured with a supervised and/or unsupervised machine learning process to train and output multiple models, such as the prognosis prediction models 150 and the diagnostic prediction model 160 that have been trained in the machine learning process based on non-overlapping or partially overlapping sets of features. In some embodiments, the different sets of features that are associated with multiple models can be implemented on the prediction server 115B to create a more robust system that includes an ensemble or collection of models. In such embodiments, the prediction server 115B can predict prognostic and diagnostic data based on ESP operational data for different operators, customers, ESPs, ESP components, data sources, ESP operational data types, or other statistically correlated patterns observed in the received ESP operational data. In this way, the model or ensemble of models can be trained to generate diagnostic and prognostic data as outputs in situations when certain ESP operational data which are used in a given prediction model may be missing or incomplete.

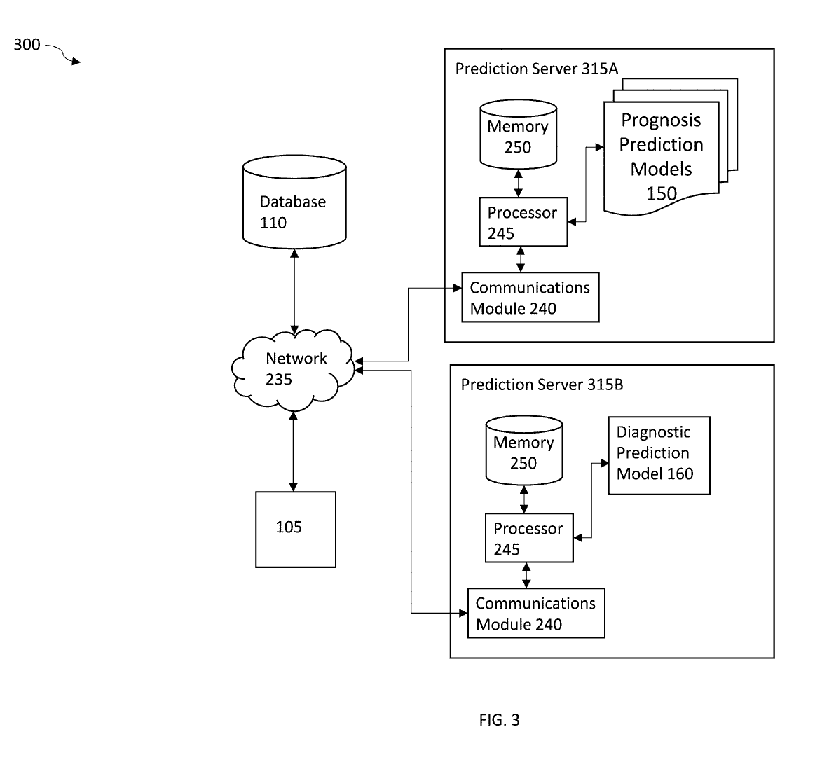

FIG. 3 is a block diagram illustrating the example client and server from the architecture of FIG. 1 in an exemplary deployed prediction system 300. The block diagram of the deployed prediction system 300 includes an example client 105 similar to the client described in relation to architecture 100 of FIG. 1. The deployed prediction system 300 also includes a prediction server 315A configured with one or more trained prognosis prediction models 150 and a second prediction server 315B, deployed remotely or separately from the prediction server 315A. For example, prediction server 315A can be configured in a cloud computing environment associated with the production operators' primary data center. Prediction server 315B can be configured in a computing environment located at a well site that can be coupled to the ESPs and associated components. The prediction server 315B can be configured with a diagnostic prediction model 160. The prediction servers 315A and 315B are similar to the prediction server 115B described in relation to the system 200b of FIG. 2B, according to certain aspects of the disclosure.

As shown in FIG. 3, the client 105, the database 110, and the servers 315A and 315B are connected over the network 235. The client 105 and each of the servers 315A and 315B can be configured to exchange data that can be used to determine prognostic and diagnostic data associated with the operating conditions of one or more ESPs. Prognostic data generated by prediction server 315A can measurements of a remaining amount of useful life, a survivability measurement associated with a pre-determined time span, and a Weibull distribution identifying the probability for failure as a function of time. In some embodiments, the prognostic data can also include uncertainty bounds or confidence intervals. Diagnostic data can include ESP operational data that the diagnostic prediction model 160 has identified as anomalous. In some embodiments, the diagnostic data can also include alerts or notifications that are triggered based on determining anomalous data present in the received ESP operational data. Additionally, the client 105 and the servers 315A and 315B may share ESP operational data stored in database 110 that can be used in the deployed prediction 300 in order to predict prognostic and diagnostic data based on ESP operational data. The ESP operational data stored in the database 110 can include customer provided data, historical operational data, as well as operational data that is associated with different configurations of ESPs.

The servers 315A and 315B each include a communications module 240, a processor 245, and a memory 250 that includes one or more machine readable storage mediums containing program instructions for causing a computer to generate prognostic or diagnostic data based on ESP operational data. The processors 245 of the servers 315A and 315B are configured to execute instructions, such as instructions physically coded into the processors 245, instructions received from software in memory 250, or a combination of both. For example, the processor 245 of the server 315A can execute instructions to generate prognostic data based on ESP operational data that may be output to a client 105. Similarly, the processor 245 of the server 315B can execute instructions to generate diagnostic data based on ESP operational data that may be output to a client 105.

The techniques described herein may further be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

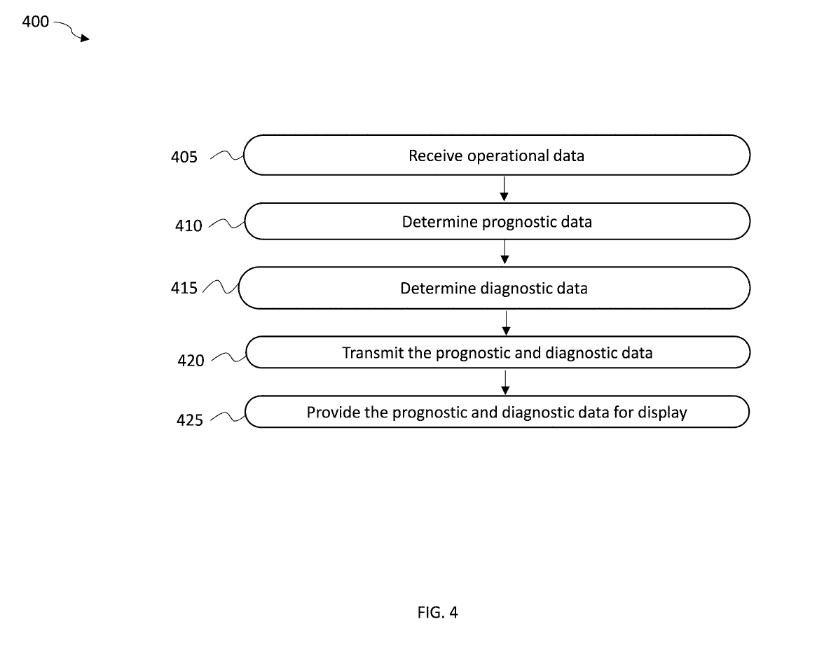

FIG. 4 is a flow diagram illustrating an exemplary embodiment of a method 400 for generating prognostic and diagnostic data based on ESP operational data using the client/server architecture described in relation to FIGS. 1, 2A, and 2B and the trained prognosis prediction models 150 and the diagnostic prediction model 160 generated in a machine learning process using the training system 200a and 200b, as shown and described in relation to FIGS. 2A and 2B. In certain aspects, embodiments of the method 400 can include greater or fewer operations than illustrated in FIG. 4 and the operations can be performed in a different order than illustrated in FIG. 4.

For example, in operation 405, a client 105 receives an input including a plurality of ESP operational data. The operational data may include voltage data, current data, frequency data, vibration data, load data, or the like associated with an operating condition of the ESP. The ESP operational data can also include ESP intake pressure data, wellhead pressure data, intake temperature data, ESP motor temperature data, ESP RPM data, pump operational status data, torque data, discharge pressure data, production flow data, and the like. The operational data may be received by the client 105 in regard to a specific operating condition including a motor failure, a pump failure, a cable or motor lead extension failure, a seal failure, a shaft and/or coupling failure, or the like. The client 105 can receive ESP operational data directly from a controller or a sensor that can be coupled to an ESP. In some embodiments, the ESP operational data can be received by a client 105 coupled to a SCADA system in which the ESP is configured. In some embodiments, a client 105 can receive the ESP operational data from a database, such as database 110. The ESP operational data may be historical ESP operational data or may be live, streaming ESP operational data that is received by the client in real-time or near real-time from the ESP.

Upon receiving the ESP operational data, the client 105 can transmit the operational data to a server, such as server 115. In some embodiments, the ESP operational data can be transmitted to the server 115 as training data 120. In other embodiments, the ESP operational data can be transmitted to the server 115 as prediction data 125. During the training phase of a machine learning process, the client 105 and/or the database 110 can transmit the input, as training data 120 to the model training server 115A of FIG. 2B. During the prediction phase of the machine learning process, the client 105 and/or the database 110 can provide prediction data 125 to the prediction server 115B of FIG. 2B. The inputs can be transmitted from the client 105 and/or the database 110 to the server 115 via the network 235.

In operation 410, the server 115 determines prognostic data. The server 115 determines prognostic data based on ESP operational data via the prognostic prediction models 150, for example a trained prediction model implementing a long short-term memory (LSTM) algorithm or a recurrent neural network architecture. When the server 115 receives prediction data 125, the server 115 can apply the trained prognostic prediction model 150 generated as a result of the training phase of the machine learning process to the transmitted inputs and can generate one or more prognosis measurements included in the prognostic data 155. The prognostic data 155 can be determined as a result of the training approach employed during the training phase where by a number of prognosis prediction models and corresponding supervised learning techniques were applied to the training data 120 so that a deployable trained prognosis prediction model 150 can be generated.

In some embodiments, the prognosis data 155 can include outputs which require further input to cause execution of executable content which can be configured on the client 105 and/or the server 115. For example, the prognosis prediction model 150 can be trained to output a uniform resource locator (URL) or “web address” requiring a user to click or otherwise select the URL in a web-based environment to cause the computing device to navigate to the content stored at the URL location. In some embodiments, execution of the executable content included in the prognostic data 155 can cause a change in operation of the ESP and/or one of its components. For example, execution of the executable content included in the prognostic data 155 can cause the ESP to cease operation or change a mode of operation.

In operation 415, the server 115 determines diagnostic data. The server 115 determines diagnostic data based on ESP operational data via the diagnostic prediction model 160. The diagnostic prediction model 160 can include an autoencoder based convolution architecture that can be optimized for anomaly detection of the ESP operational data. When the server 115 receives prediction data 125, the server 115 can apply the trained diagnostic prediction model 160 generated as a result of the training phase of the machine learning process to the transmitted inputs and can generate one or more diagnostic measurements included in the diagnostic data 165. The diagnostic data 165 can be determined as a result of the training approach employed during the training phase where by a number of prognosis prediction models and corresponding unsupervised learning techniques were applied to the training data 120 so that a deployable trained diagnostic prediction model 160 can be generated. In some embodiments, the diagnostic data 165 can include outputs which require further input to cause execution of executable content which can be configured on the client 105 and/or the server 115. For example, the diagnostic prediction model 160 can be trained to output an alert or a notification based on the diagnostic data 165. The alert or notification can include executable content requiring a user to accept or otherwise acknowledge the alert. In some embodiments, the diagnostic prediction model 160 can be trained to output a uniform resource locator (URL) or “web address” requiring a user to click or otherwise select the URL in a web-based environment to cause the computing device to navigate to the content stored at the URL location. In some embodiments, execution of the executable content included in the diagnostic data 165 can cause a change in operation of the ESP and/or one of its components. For example, execution of the executable content included in the diagnostic data 165 can cause the ESP to cease operation or change a mode of operation.

In operation 420, the server 115 transmits the prognostic data and the diagnostic data to the client 105 and/or the database 110 via the network 235. The client 105 can further provide the outputs to a user within an application from which the ESP operational data was received. In some embodiments, the client 105 can receive the prognostic and diagnostic data outputs and further transmit the outputs to the database 110 for storage, thereby reducing the amount of memory resources needed at client 105. In this way, the database 110 can include newly generated prognostic and diagnostic outputs that can be added to a production operators ESP operation and condition monitoring database which may be stored in database 110.

In operation 425, the client 105 can provide the prognostic and diagnostic data for display, such as within a GUI configured on the client 105. In some embodiments, the client 105 provide the prognostic and diagnostic data in a report, as an annotation to one or more related datasets of ESP operational data, or as an input to a modeling and simulation environment configured to model and simulate ESP operational behavior.

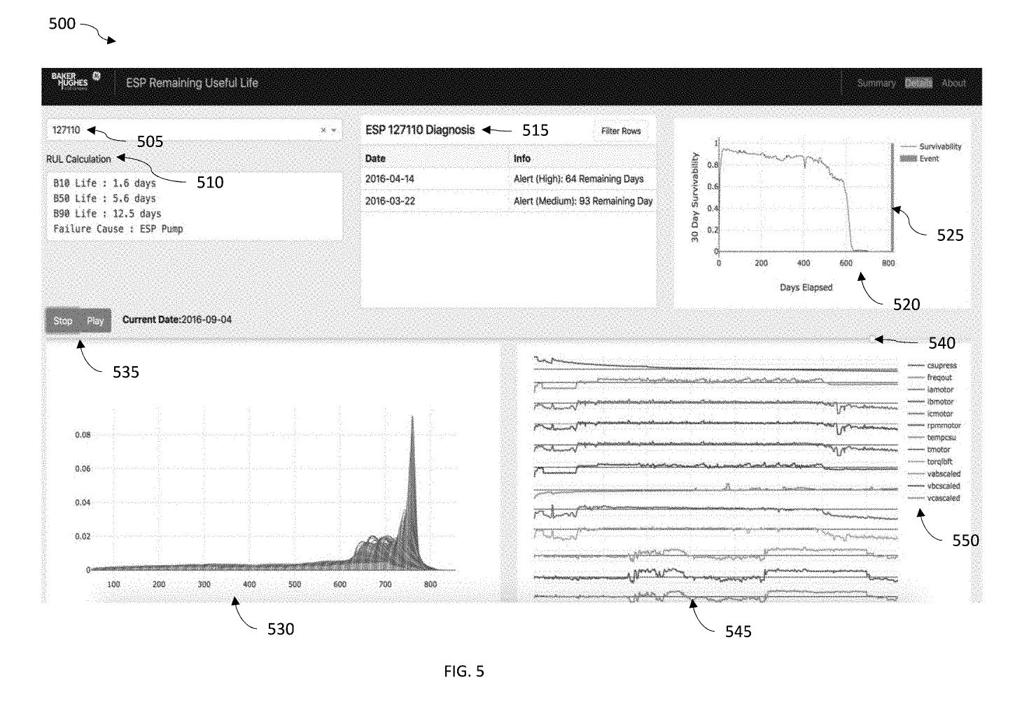

FIG. 5 is a diagram illustrating an exemplary embodiment of a GUI 500 that can be configured on a client 105 and/or server 115 to display prognostic data 155 and diagnostic data 165 for an ESP. The GUI 500 includes an ESP identifier 505 which can include data to identify the particular ESP related to the prognostic data 155 and diagnostic data 165 displayed in the GUI 500. The GUI 500 also includes one or more remaining useful life (RUL) calculations 510 for the ESP. The RUL calculations 510 can include estimates of an amount of time remaining in the operational lifespan of the ESP. The RUL calculations 510 can include different forecast estimates for the amount of remaining useful life based on degraded operating performance conditions and can also identify the eventual predicted cause of ESP failure.

The GUI 500 also includes survivability data 520. The survivability data 520 displays probability data indicative of the likelihood that the ESP will remain operational for a pre-defined duration into the future and is presented with respect to a cumulative amount of elapsed operational time. The survivability data 520 also includes event data 525. The event data 525 can indicate a time period forecast into the future when the ESP is likely to fail.

The GUI 500 further includes Weibull distribution data 530 indicating the probability of failure as a function of time. The Weibull distribution data 530 can include different plots for each of the one or more components of the particular ESP. The Weibull distribution data 530 can display the probability of ESP failure for the current date or can show past and predicted dates by interacting with animation controls 535. The animation controls 535 allow a user to “play” or “stop” an animated display of the Weibull distribution 530 as time-series data. A user can further adjust the display of the Weibull distribution data 530 by interacting with a slider 540. In this way, the user can adjust the slide to show Weibull distribution data for a specific past or future time point.

The GUI 500 also includes a component diagnostic display 545 including the operational data corresponding to various components or sensors of the ESP. A component identification legend 550 provides a legend identifying each of the various ESP components including sensors which may be coupled to the ESP or ESP components. In this way, the user can view the operational data associated with one or more components of the ESP.

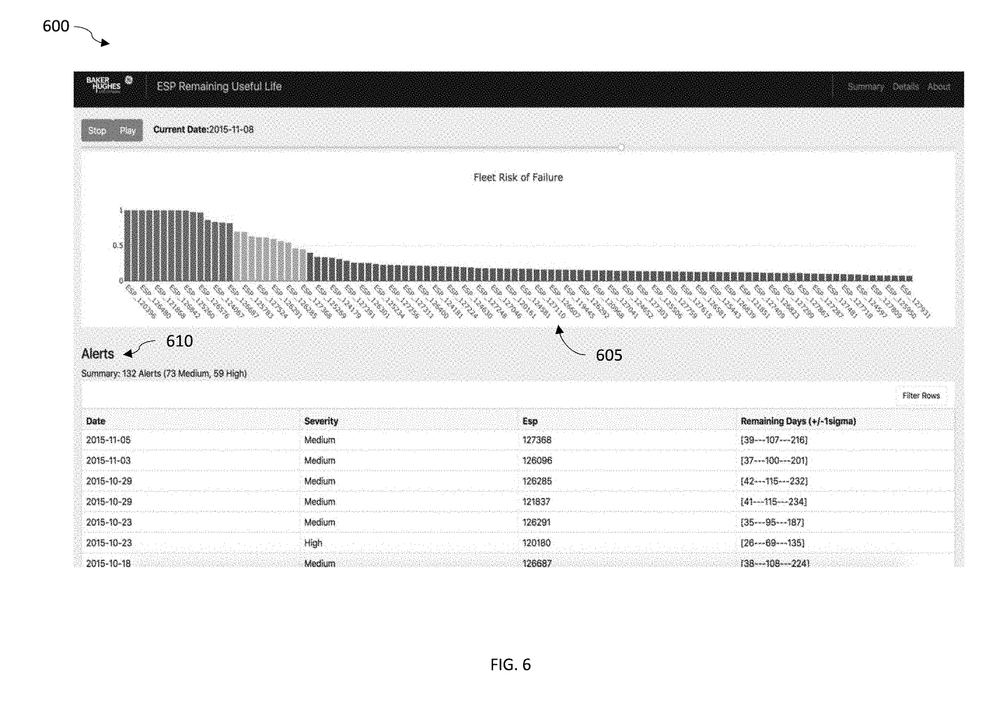

FIG. 6 is a diagram illustrating an exemplary embodiment of a GUI 600 that can be configured on a client 105 and/or server 115 to display prognostic data 155 and diagnostic data 165 for multiple ESPs. The GUI 600 includes a fleet failure probability distribution 605. The fleet failure probability distribution 605 displays risk values or failure probabilities for ESPs. The risk value can be a value between 0.0 and 1.0. In some embodiments, the fleet failure probability distribution 605 can include coloring, shading, grouping, or other similar graphical or textual affordances to identify pre-determined ranges of failure probabilities. For example, ESPs determined to have a failure probability of greater than 0.75 (or above 75%) can be grouped and identified by a first color, such as red. ESPs determined to have a failure probability between 0.5 and 0.75 (or between 50% and 75%) can be identified using a second color, such as yellow. ESPs determined to have a failure probability below 0.5 (or below 50%) can be grouped and identified by a third color, such as green. In this way the GUI 600 can provide a concise presentation of the failure probability for multiple ESPs to aid prioritization of the ESPs.

As further shown in FIG. 6, the GUI 600 includes an alert display 610. The alert display 610 summarizes alerts for ESPs. The alerts can be generated based on determining that the ESP prognostic data 155 has exceed a desired operational condition or performance threshold. The alert display 610 includes a date of the alert, a severity of the alert, the ESP associated with the alert, and RUL data identifying the number of days remaining for the ESP to continue operating. The RUL data can also be presented with uncertainty or confidence intervals.

The improved ESP diagnostic and prognostic system described herein addresses the technical problem of efficiently generating diagnostic and prognostic data based on ESP operational data. The problem of determining and generating accurate, detailed, diagnostic and prognostic data for ESPs can be difficult and time-consuming, requiring significant computing resources to store multiple databases containing large libraries of operational data which must be catalogued and indexed appropriately before being useful for generating diagnostic and prognostic data. The exemplary technical effects of the methods, systems, and devices described herein include, by way of non-limiting example, generating diagnostic and prognostic data based on ESP operational data using a predictive model trained in a machine learning process. The predictive model reduces the need for significant computing resources storing large databases of ESP operational data and provides the exemplary technical effect of reducing calculation times, improving diagnostic and prognostic metric generation, and improved visualization of the generated diagnostic and prognostic data. In addition, the precision and specificity of the diagnostic and prognostic data provided by a ESP condition monitoring application or a SCADA system, can be improved such that the application or SCADA system are able to more efficiently generate precise diagnostic and prognostic metrics based on ESP operational data. Thus the system represents an improvement of computer functionality that processes ESP operational data and generates diagnostic and prognostic data corresponding to one or more operating conditions of the ESP. Additionally, the clients 105 can include an improved display or graphical user interface (GUI) that provides more efficient visualization and execution of diagnostic and prognostic data such as when responding to alerts or notifications for anomalous operating conditions, planning ESP or ESP component replacement, or managing well site production. Existing ESP condition monitoring applications typically do not include such robust interfaces to provide diagnostic and prognostic data generated by a trained prediction model. Existing applications are limited to interfaces which may provide current or historical operational data but lack diagnostic and prognostic data predicted based on ESP operational data in real time or near real-time. The improved ESP diagnostic and prognostic system provides a predictive, automatic, user-configurable system capable of generating diagnostic and prognostic data based on inputs that include minimal indications of future operating conditions in the ESP operational data.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., a GPU (graphical processing unit), an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving operational data associated with an operating condition of a pump;
determining prognostic data using the received operational data and a first predictive model trained to receive operational data and, in response to the receiving, generate prognostic data associated with the pump, the prognostic data including a plurality of metrics associated with the pump and predicted in relation to the operational data; and
transmitting the prognostic data, wherein at least one of the receiving, the determining, and the transmitting is performed by at least one data processor forming part of at least one computing system.

2. The method of claim 1, wherein the operational data used in determining prognostic data associated with the pump includes sensor data received during operation of the pump.

3. The method of claim 1, wherein the operating condition includes a motor failure, a pump failure, a cable or motor lead extension failure, a seal failure, a shaft failure, and coupling failure.

4. The method of claim 1, further comprising aggregating and normalizing the operational data prior to determining prognostic data associated with the pump.

5. The method of claim 1, wherein the plurality of metrics included in the determined prognostic data includes at least one of a remaining use life estimate for the pump, a survivability estimate for the pump, and a Weibull distribution for a failure of the pump as a function of time.

6. The method of claim 5, wherein the remaining use life estimate and the survivability estimate each include a confidence interval estimate.

7. The method of claim 1 further comprising,
determining one or more of the plurality of metrics included in the prognostic data exceed a pre-determined threshold value associated with the future operating condition of the pump;
assigning, in response to the determining, a risk value to the pump; and
prioritizing the pump based on the assigned risk value.

8. The method of claim 1, further comprising,
generating a notification based on determining one or more of the plurality of metrics included in the prognostic data exceed a pre-determined threshold value associated with the future operating condition of the pump; and
providing the notification to one or more computing devices communicatively coupled to the at least one data processor.

9. The method of claim 1, further comprising,
determining the diagnostic data using the received operational data and a second predictive model, the second predictive model trained to generate diagnostic data associated with the pump, the diagnostic data including a plurality of metrics associated with an anomalous operating condition of the pump and predicted in relation to the operational data; and
transmitting the diagnostic data to a computing device communicatively coupled to the at least one data processor, the transmission causing the computing device to provide the diagnostic data for display.

10. The method of claim 9, wherein the operational data used in determining diagnostic data associated with the pump includes streaming sensor data received by the data processor during operation of the one or more pumps.

11. A system comprising:
a first computing device, including a data processor and a memory storing computer-readable instructions and a plurality of prediction models, the processor configured to execute the computer-readable instructions, which when executed, cause the processor to perform operations including
receiving operational data associated with an operating condition a pump;
determining prognostic data using the received operational data and a first predictive model trained to receive operational data and, in response to the receiving, generate prognostic data associated with the pump, the prognostic data including a plurality of metrics associated with the pump and predicted in relation to the operational data,
determining diagnostic data using the received operational data and a second predictive model trained to receive operational data and, in response to the receiving, generate diagnostic data associated with the pump, the diagnostic data including a plurality of metrics associated with an anomalous operating condition of the pump and predicted in relation to the operational data, and
transmitting the prognostic data and the diagnostic data; and
a second computing device coupled to the first computing device via a network, the second computing device including a display configured to present the transmitted prognostic data and the diagnostic data via the display.

12. The system of claim 11, wherein the operational data used in determining prognostic data associated with the pump includes sensor data received during operation of the pump.

13. The system of claim 11, wherein the operating condition includes a motor failure, a pump failure, a cable or motor lead extension failure, a seal failure, a shaft failure, and coupling failure

14. The system of claim 11, wherein the operational data used in determining diagnostic data associated with the pump includes streaming sensor data received during operation of the pump.

15. The system of claim 11, wherein the computer-readable instructions further cause the processor to aggregate and normalize the operational data prior to determining prognostic data associated with the pump.

16. The system of claim 11, wherein the plurality of metrics included in the determined prognostic data includes at least one of a remaining use life estimate for the pump, a survivability estimate for the pump, and a Weibull distribution determined for a failure of the pump as a function of time.

17. The system of claim 16, wherein the remaining use life estimate and the survivability estimate each include a confidence interval estimate.

18. The system of claim 11, wherein the computer-readable instructions further cause the processor to
determine one or more of the plurality of metrics included in the prognostic data exceed a pre-determined threshold value associated with the future operating condition of the pump;
assign, in response to the determining, a risk value to the pump; and
prioritize the pump based on the assigned risk value.

19. The system of claim 11, wherein the computer-readable instructions further cause the processor to
generate a notification based on determining one or more of the plurality of metrics included in the prognostic data exceed a pre-determined threshold value associated with the future operating condition of the pump; and
provide the notification to the second computing device and/or one or more computing devices communicatively coupled to the first or second computing devices for display.

20. The system of claim 11, wherein the display of the second computing device includes a graphical user interface configured to present the prognostic data and/or the diagnostic data as graphical and/or tabular representations of time-series data associated with the one or more pumps, the graphical user interface further configured to filter the time-series data in regard to one or more of the plurality of metrics.

21. A non-transitory computer readable storage medium containing program instructions, which when executed by at least one data processor causes the at least one data processor to perform operations comprising:
receive, by a first computing device, operational data associated with an operating condition of a pump, the operating condition including at least one of a motor failure, a pump failure, a cable or motor lead extension failure, a seal failure, a shaft failure, and coupling failure;
determine, by the first computing device, prognostic data using the received operational data and a first predictive model trained to receive operational data and, in response to the receiving, generate prognostic data associated with the pump, the prognostic data including a plurality of metrics associated with the pump and predicted in relation to the operational data,
determine, by the first computing device, diagnostic data using the received operational data and a second predictive model trained to receive operational data and, in response to the receiving, generate diagnostic data associated with the pump, the diagnostic data including a plurality of metrics associated with an anomalous operating condition of the pump and predicted in relation to the operational data,
transmit, by the first computing device, the prognostic data and the diagnostic data to a second computing device coupled to the first computing device via a network, and
provide, via a display of the second computing device, the prognostic data and the diagnostic data for display.

22. The non-transitory computer readable storage medium of claim 21, where in the instructions are configured in a microservices computing architecture implemented within an oil and gas production environment.
